(19) United States
(12) Patent Application Publication
(10) Pub. No.: US 2025/0100472 A1
(43) Pub. Date: Mar. 27, 2025

(54) ROUTING STRUCTURE

(71) Applicant: YAZAKI CORPORATION, Tokyo (JP)

(72) Inventors: Kosuke Tomosada, Makinohara-shi (JP); Eri Ueda, Makinohara-shi (JP)

(21) Appl. No.: 18/892,310

(22) Filed: Sep. 20, 2024

(30) Foreign Application Priority Data
Sep. 26, 2023 (JP) 2023-163176

(51) Int. Cl. B60R 16/02; B60J 7/043; H02G 11/00

(52) U.S. Cl. CPC B60R 16/0215; B60J 7/043; H02G 11/006

(57) ABSTRACT

A routing structure includes: a first fixed portion fixed to a vehicle body of a vehicle; a second fixed portion fixed to a sliding body that moves in a vehicle front-rear direction with respect to an opening provided in a roof of the vehicle body; an exterior member that has a first end portion held by the first fixed portion and a second end portion held by the second fixed portion; an electric wire inserted into the exterior member; a plate-shaped biasing member inserted into the exterior member and forms a curved portion curved in the vehicle front-rear direction between the first end portion and the second end portion of the exterior member; and a suppressing portion provided on the biasing member and increases rigidity of a portion forming the curved portion to suppress the biasing member from having a narrowing shape at the curved portion.

### CROSS-REFERENCE TO RELATED APPLICATION(S)

The present application claims priority to and incorporates by reference the entire contents of Japanese Patent Application No. 2023-163176 filed in Japan on Sep. 26, 2023.

### BACKGROUND OF THE INVENTION

### 1. Field of the Invention

The present invention relates to a routing structure.

### 2. Description of the Related Art

Hitherto, there has been a power feeding device for a sliding body. Japanese Patent Application Laid-open No. 2011-151906 A discloses a power feeding device for a sliding body, the power feeding device including a wire harness routed over a vehicle body and the sliding body that is slidably provided in the vehicle body and opens and closes an opening formed in the vehicle body.

The inventors of the present application have considered arrangement of a rigid biasing member inside an exterior member in a case where a routing structure between a vehicle body and a sliding body includes the exterior member. Here, it is preferable to reduce the rigidity of the biasing member from the viewpoint of securing durability against bending of the biasing member. On the other hand, in a case where curved portions are formed in the exterior member and the biasing member, when the rigidity of the biasing member is low, the curved portion is likely to have a narrowing shape. When the curved portion has a narrowing shape, a bending radius of an electric wire is decreased.

### SUMMARY OF THE INVENTION

An object of the present invention is to provide a routing structure capable of suppressing a biasing member from having a narrowing shape.

In order to achieve the above mentioned object, a routing structure according to one aspect of the present invention includes a first fixed portion that is fixed to a vehicle body of a vehicle; a second fixed portion that is fixed to a sliding body that moves in a vehicle front-rear direction with respect to an opening provided in a roof of the vehicle body; an exterior member that has a first end portion held by the first fixed portion, and a second end portion held by the second fixed portion; an electric wire that is inserted into the exterior member; a plate-shaped biasing member that is inserted into the exterior member, and forms a curved portion curved in the vehicle front-rear direction between the first end portion and the second end portion of the exterior member; and a suppressing portion that is provided on the biasing member, and increases rigidity of a portion forming the curved portion to suppress the biasing member from having a narrowing shape at the curved portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a routing structure according to an embodiment;

FIG. 2 is a side view of the routing structure according to the embodiment;

FIG. 3 is a cross-sectional view of the routing structure according to the embodiment;

FIG. 4 is a side view of the routing structure according to the embodiment;

FIG. 5 is a view for describing a narrowing shape;

FIG. 6 is a side view of a suppressing portion according to the embodiment;

FIG. 7 is a side view of the suppressing portion according to the embodiment;

FIG. 8 is a side view of the suppressing portion according to the embodiment;

FIG. 9 is a side view of the suppressing portion according to the embodiment; and

FIG. 10 is a side view of the suppressing portion according to the embodiment.

### DETAILED DESCRIPTION OF THE PREFERRED EMBODIMENTS

Hereinafter, a routing structure according to an embodiment of the present invention will be described in detail with reference to the drawings. Note that the present invention is not limited by the embodiment. In addition, constituent elements in the following embodiment include those that can be easily assumed by those skilled in the art or those that are substantially the same.

### Embodiment

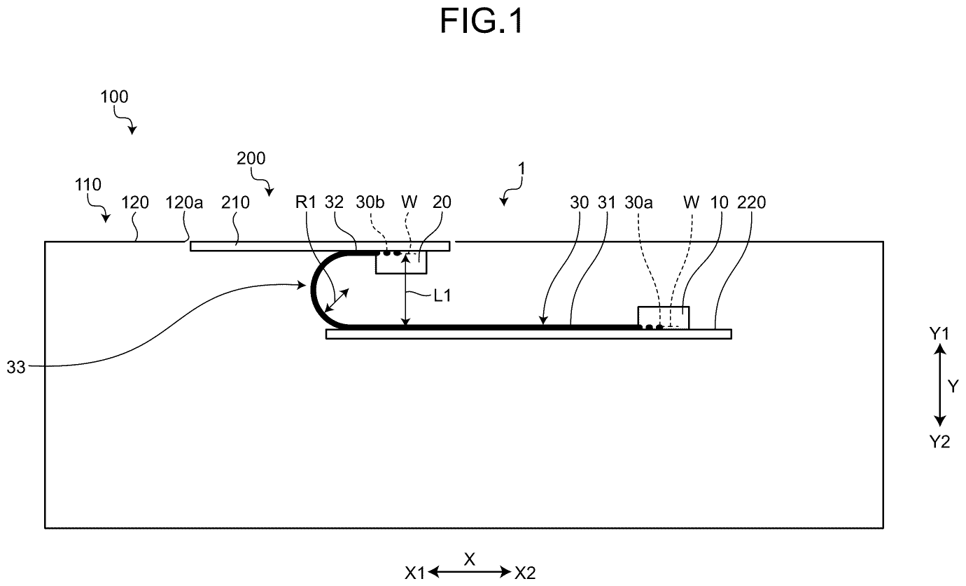

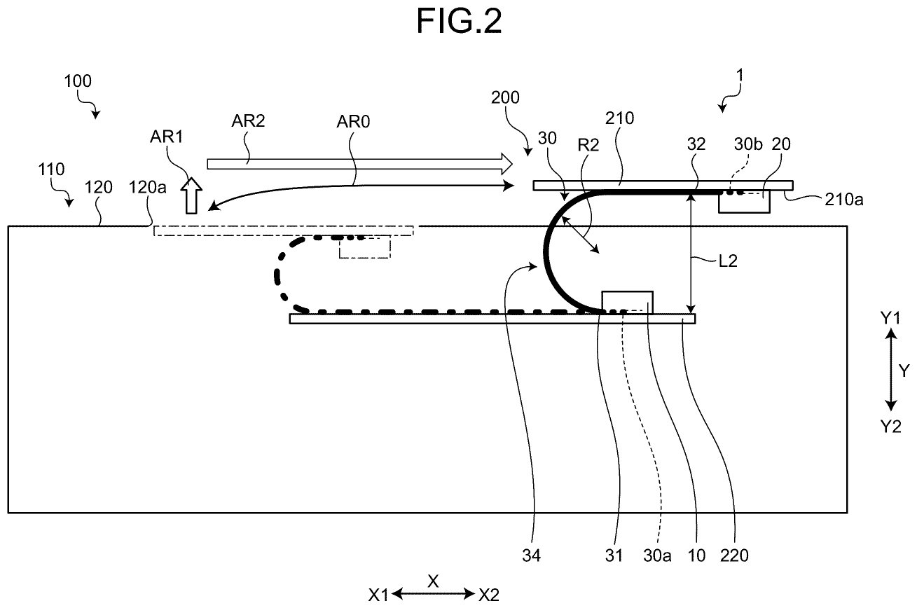

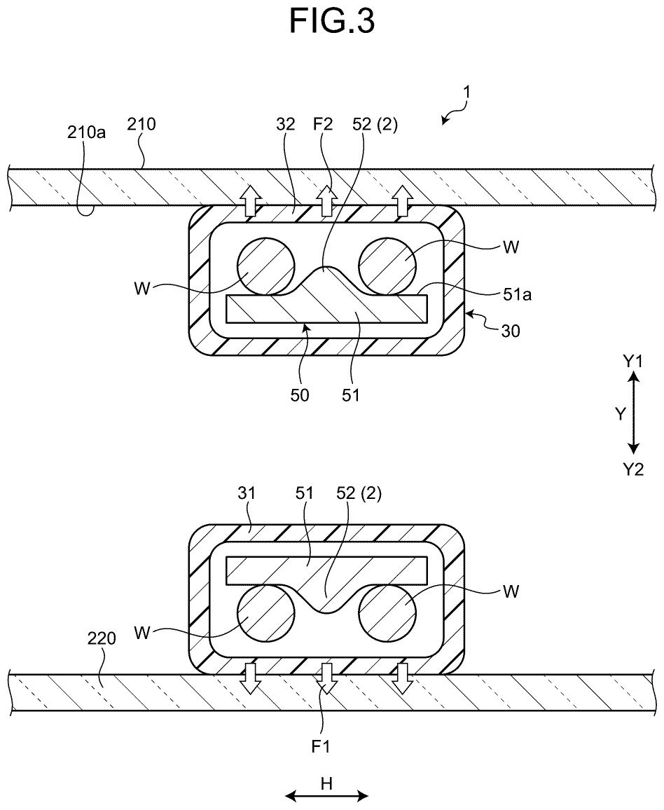

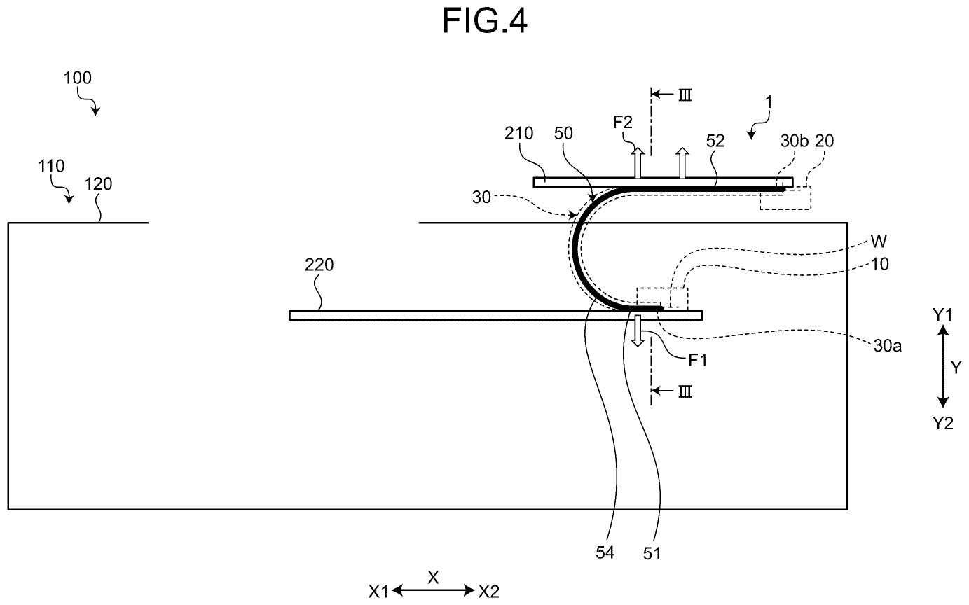

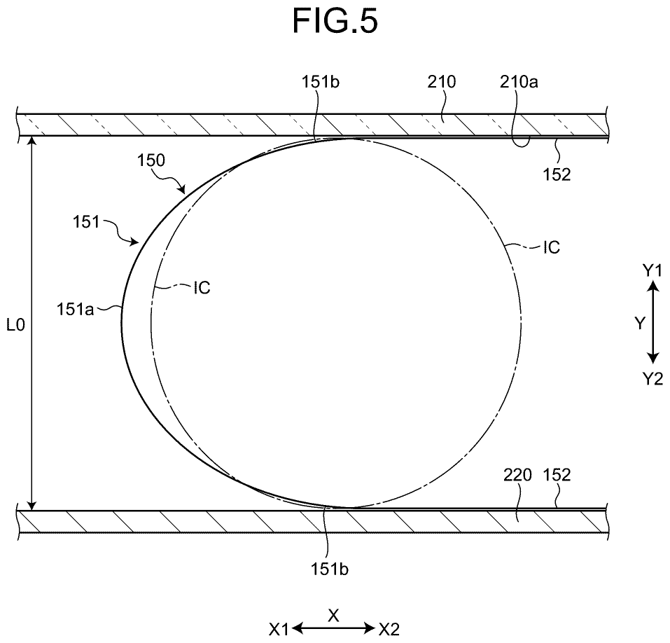

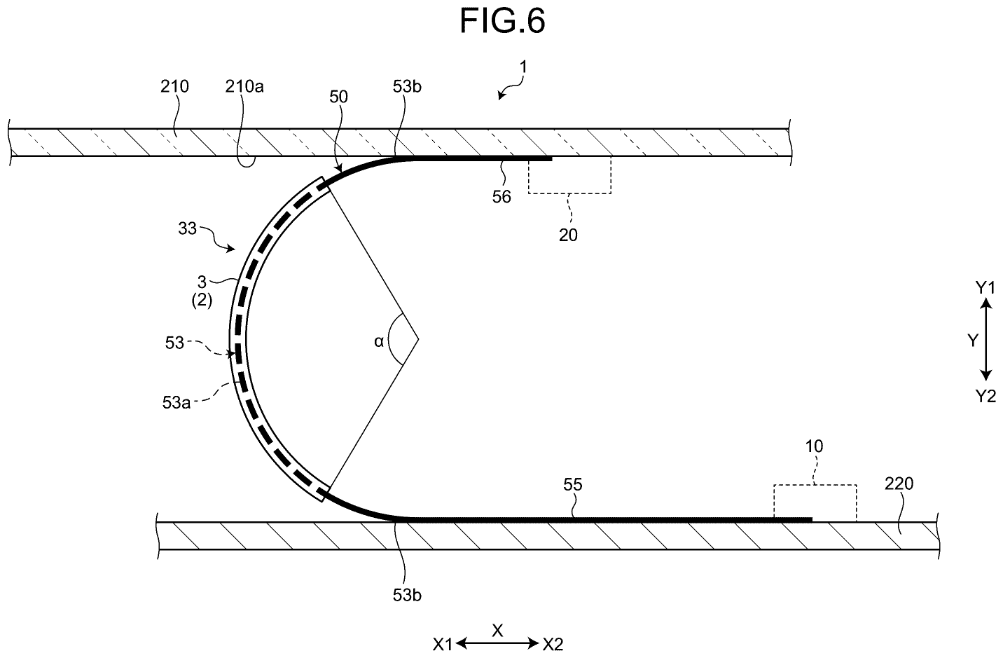

An embodiment will be described with reference to FIGS. 1 to 10. The present embodiment relates to a routing structure. FIGS. 1 and 2 are side views of the routing structure according to the embodiment, FIG. 3 is a cross-sectional view of the routing structure according to the embodiment, FIG. 4 is a side view of the routing structure according to the embodiment, FIG. 5 is a view for describing a narrowing shape, and FIGS. 6 to 10 are side views of the suppressing portion according to the embodiment. FIG. 3 illustrates a cross section taken along line III-III of FIG. 4.

As illustrated in FIG. 1, a routing structure 1 of the embodiment is applied to a sunroof 200 of a vehicle 100. The vehicle 100 is, for example, an automobile on which a power source such as a motor or an engine is mounted. The vehicle 100 includes a vehicle body 110. The vehicle body 110 includes a roof 120 that covers a vehicle interior. The roof 120 has an opening 120a that is opened upward.

The vehicle 100 includes a sunroof 200 that opens and closes the opening 120a. The sunroof 200 includes a sliding body 210, a rail 220, and the routing structure 1. The sliding body 210 is a member that slides in a vehicle front-rear direction X with respect to the opening 120a. The sliding body 210 of the present embodiment is a plate-shaped member that closes the opening 120a or opens the opening 120a. The sliding body 210 may be glass that can transmit light.

The sunroof 200 includes a mechanism such as a link mechanism that moves the sliding body 210 along a predetermined path, and a drive source such as a motor that operates the mechanism. The sunroof 200 moves the sliding body 210 between a fully closed position where the opening 120a is closed and a fully open position where the opening 120a is opened. FIG. 1 illustrates the sliding body 210 at the fully closed position. FIG. 2 illustrates the sliding body 210 at the fully open position.

The rail 220 is fixed to the vehicle body 110. The rail 220 extends in the vehicle front-rear direction X. The rail 220 supports the mechanism that moves the sliding body 210, and guides the mechanism in the vehicle front-rear direction X. The rail 220 further supports an exterior member 30 to form a first extending portion 31 in the exterior member 30.

The sunroof 200 of the present embodiment moves the sliding body 210 along a path AR0 illustrated in FIG. 2. The movement of the sliding body 210 along the path AR0 includes movement in the vehicle front-rear direction X and movement in a vehicle up-down direction Y. When the sliding body 210 moves from the fully closed position to the fully open position, the sliding body 210 moves toward an upper side Y1 in the vehicle up-down direction Y as indicated by an arrow AR1 in FIG. 2 and moves toward a rear side X2 in the vehicle front-rear direction X.

Conversely, when the sliding body 210 moves from the fully open position to the fully closed position, the sliding body 210 moves toward a front side X1 in the vehicle front-rear direction X and moves toward a lower side Y2 in the vehicle up-down direction Y.

As illustrated in FIGS. 1 to 3, the routing structure 1 includes a first fixed portion 10, a second fixed portion 20, an exterior member 30, an electric wire W, and a biasing member 50. The exterior member 30 and the electric wire W form a wire harness routed between the vehicle body 110 and the sliding body 210.

The first fixed portion 10 is a member fixed to the vehicle body 110 of the vehicle 100. The first fixed portion 10 may be a protector that protects the electric wire W. The first fixed portion 10 is molded using, for example, an insulating synthetic resin. The first fixed portion 10 has a space in which the electric wire W is routed and includes a holding structure for holding the exterior member 30.

The second fixed portion 20 is a member fixed to the sliding body 210 of the sunroof 200. The second fixed portion 20 may be a protector that protects the electric wire W. The second fixed portion 20 is molded using, for example, an insulating synthetic resin. The second fixed portion 20 has a space in which the electric wire W is routed and includes a holding structure for holding the exterior member 30.

The exterior member 30 is an elastically deformable tubular member. The exterior member 30 is, for example, a member called a corrugated tube. The exterior member 30 is molded using, for example, an insulating synthetic resin. The exterior member 30 may have a bellows shape.

The exterior member 30 has a first end portion 30a held by the first fixed portion 10 and a second end portion 30b held by the second fixed portion 20. The first fixed portion 10 holds the first end portion 30a such that the exterior member 30 extends from the first fixed portion 10 along the rail 220 in the vehicle front-rear direction X. The first fixed portion 10 of the present embodiment holds the first end portion 30a such that the exterior member 30 extends from the first fixed portion 10 toward the front side X1.

The second fixed portion 20 holds the second end portion 30b such that the exterior member 30 extends from the second fixed portion 20 along the sliding body 210 in the vehicle front-rear direction X. The second fixed portion 20 of the present embodiment holds the second end portion 30b such that the exterior member 30 extends from the second fixed portion 20 toward the front side X1.

The electric wire W and the biasing member 50 are inserted into the exterior member 30. The electric wire W is, for example, a sheathed electric wire including a stranded wire and a sheath. The electric wire W may be a flat routing member, a printed circuit body, or another circuit body. The electric wire W led out from the first end portion 30a is connected to a power supply or a control device arranged in the vehicle body 110. The electric wire W led out from the second end portion 30b is connected to a load arranged on the sliding body 210. The load arranged on the sliding body 210 may be, for example, a lighting device, a light control film arranged on the glass of the sliding body 210, or another electric load.

As illustrated in FIGS. 1 and 2, the exterior member 30 has curved portions 33 and 34 that are curved in the vehicle front-rear direction X between the first end portion 30a and the second end portion 30b. The curved portions 33 and 34 are formed by the biasing member 50. The curved portion 33 illustrated in FIG. 1 is a curved portion formed in the exterior member 30 in a state in which the sliding body 210 is at the fully closed position. The curved portion 33 has a radius R1. The curved portion 34 illustrated in FIG. 2 is a curved portion formed in the exterior member 30 in a state in which the sliding body 210 is at the fully open position. The curved portion 34 has a radius R2. The electric wire W in which the curved portions 33 and 34 are formed has a U shape or a J shape.

As illustrated in FIG. 1, when the sliding body 210 is at the fully closed position, a distance between the second end portion 30b and the first end portion 30a in the vehicle up-down direction Y is a first distance L1. The radius R1 of the curved portion 33 is half the first distance L1.

As illustrated in FIG. 2, when the sliding body 210 is at the fully open position, a distance between the second end portion 30b and the first end portion 30a in the vehicle up-down direction Y is a second distance L2. The radius R2 of the curved portion 34 is half the second distance L2.

In the sunroof 200 of the present embodiment, the second distance L2 at the fully open position is larger than the first distance L1 at the fully closed position. Accordingly, the radius R1 of the curved portion 33 when the sliding body 210 is at the fully closed position is smaller than the radius R2 of the curved portion 34 when the sliding body 210 is at the fully open position. The radius R1 when the sliding body 210 is at the fully closed position is smaller than a radius of a curved shape formed in the biasing member 50 when the sliding body 210 is at another position. In other words, the radius of the curved shape formed in the biasing member 50 is minimized when the sliding body 210 is at the fully closed position.

The second end portion 30b of the exterior member 30 moves together with the sliding body 210. At this time, the exterior member 30 follows movement of the second fixed portion 20 while gradually changing a position where the curved shape is formed.

The biasing member 50 of the present embodiment is a member that presses the exterior member 30 toward the sliding body 210. The biasing member 50 of the present embodiment is a plate-shaped member and is elastically deformable. The biasing member 50 is made of metal or resin.

As illustrated in FIG. 3, a cross-sectional shape of the exterior member 30 of the present embodiment is rectangular. The illustrated shape of the biasing member 50 is a substantially flat plate shape. More specifically, the biasing member 50 includes a flat plate-shaped main body 51 and a rib 52 protruding from the main body 51.

A cross-sectional shape of the main body 51 in a direction orthogonal to an axial direction of the biasing member 50 is rectangular. The main body 51 extends from one end to the other end in a width direction H in an internal space of the exterior member 30. The main body 51 faces each of the plurality of electric wires W in the vehicle up-down direction Y. In other words, the main body 51 has a width capable of supporting the plurality of electric wires W.

The rib 52 protrudes from one main surface 51a of the main body 51 in a direction orthogonal to the main surface 51a. The illustrated rib 52 is arranged at the center of the main body 51 in the width direction H. The rib 52 is arranged, for example, on the outer main surface 51a. The outer main surface 51a is a surface facing outward in a radial direction at the curved portions 33 and 34.

The biasing member 50 in FIG. 3 is arranged on an inner side of the electric wire W. Therefore, in the curved portions 33 and 34, the biasing member 50 is positioned on the inner side of the electric wire W in the radial direction. As illustrated in FIG. 3, the biasing member 50 applies pressing forces F1 and F2 to the exterior member 30.

As illustrated in FIG. 4, the exterior member 30, the electric wire W, and the biasing member 50 are routed in a state of being curved in a U shape or a J shape. That is, the biasing member 50 extends from the first fixed portion 10 to the second fixed portion 20 in a state of having a curved portion 54.

The biasing member 50 bent so as to have the curved portion 54 forms the curved portions 33 and 34 in the exterior member 30 and applies the pressing force F1 and the pressing force F2 to the exterior member 30. The pressing force F1 is a force in the vehicle up-down direction Y, and presses the exterior member 30 toward the rail 220. The pressing force F2 is a force in the vehicle up-down direction Y, and presses the exterior member 30 toward the sliding body 210. The pressing forces F1 and F2 are restoring forces generated in the bent biasing member 50.

The pressing force F1 forms the first extending portion 31 in the exterior member 30. The pressing force F2 forms the second extending portion 32 in the exterior member 30. As illustrated in FIG. 2 and the like, the second extending portion 32 is a portion extending along a vehicle interior side surface 210a of the sliding body 210. The vehicle interior side surface 210a is a surface facing the lower side Y2. In a case where the vehicle interior side surface 210a is a flat surface, the second extending portion 32 is formed linearly. In a case where the vehicle interior side surface 210a has a curved shape, the second extending portion 32 has a curved shape along the vehicle interior side surface 210a.

The biasing member 50 of the present embodiment is configured to press the exterior member 30 toward the sliding body 210 when the sliding body 210 is at the fully closed position and when the sliding body 210 is at the fully open position. In other words, the biasing member 50 has rigidity that can constantly press the exterior member 30 toward the sliding body 210 and bring the exterior member 30 into contact with the sliding body 210. Therefore, the routing structure 1 of the present embodiment can stabilize the shape of the exterior member 30. The biasing member 50 can bring the exterior member 30 into contact with the sliding body 210 against an external force such as vibration generated during traveling, for example.

As described below, the routing structure 1 of the present embodiment includes a suppressing portion 2 provided on the biasing member 50. The suppressing portion 2 increases rigidity of the curved portion of the biasing member 50 and suppresses the curved portion from having a narrowing shape.

FIG. 5 illustrates a narrowing shape formed in a biasing member 150 of a comparative example. The biasing member 150 of the comparative example has a plate shape similar to that of the main body 51, and does not include the rib 52. A curved portion 151 and a linear portion 152 are formed in the biasing member 150. The linear portion 152 is a portion extending linearly and is formed along each of a sliding body 210 and a rail 220.

The curved portion 151 has a tip portion 151a and two terminal end portions 151b. The tip portion 151a is a central portion of the curved portion 151 and has a convex shape in the vehicle front-rear direction X. The terminal end portion 151b is an end portion of the curved portion 151 in the vehicle up-down direction Y, and is a portion connected to the linear portion 152. The curved portion 151 has the narrowing shape. More specifically, the shape of the curved portion 151 is a shape in which a bending radius is decreased from the terminal end portion 151b toward the tip portion 151a.

FIG. 5 illustrates a virtual circle IC. The virtual circle IC is a circle whose diameter corresponds to a distance L0 from the rail 220 to the sliding body 210 in the vehicle up-down direction Y. A bending radius of the tip portion 151a is smaller than a radius of the virtual circle IC. In the curved portion 151 having a narrowing shape, the bending radius of the tip portion 151a is smaller than a bending radius of the terminal end portion 151b. In a case where rigidity of the biasing member 150 is low, such a narrowing shape is easily formed in the curved portion 151.

As means for suppressing the formation of the narrowing shape, it is conceivable to increase a thickness of the biasing member 150 to increase the rigidity of the biasing member 150. Meanwhile, when the thickness of the biasing member 150 is increased, durability against bending of the biasing member 150 may be deteriorated.

In the routing structure 1 of the present embodiment, the rigidity at the curved portion is secured by the rib 52 illustrated in FIG. 3. The rigidity of the biasing member 50 including the rib 52 is higher than rigidity of the biasing member 50 in a case where the rib 52 is not provided. In other words, the rigidity of the biasing member 50 including the rib 52 is higher than rigidity of the main body 51. Therefore, in the biasing member 50, a portion forming the curved portion is suppressed from having the narrowing shape. The rib 52 as the suppressing portion 2 can increase the rigidity of the biasing member 50 at the curved portion to suppress the biasing member 50 from having the narrowing shape at the curved portion and decrease the degree of narrowing.

In the biasing member 50 of the present embodiment, the rigidity is improved by the rib 52, and thus, the thickness of the main body 51 can be reduced. Therefore, it is possible to secure necessary rigidity while suppressing a decrease in durability against bending in the biasing member 50.

A cross-sectional shape of the rib 52 illustrated in FIG. 3 is a tapered shape whose dimension in the width direction H decreases as the distance from the main surface 51a increases. The cross-sectional shape of the rib 52 is, for example, a substantially triangular shape. A cross-sectional shape of a top portion of the rib 52 may be a curved shape. A cross-sectional shape of a hem portion of the rib 52 may be a curved shape.

The rib 52 extends linearly in the axial direction of the biasing member 50. The rib 52 may be provided over the entire length of the biasing member 50 from one end to the other end of the biasing member 50. In this case, the biasing member 50 is suppressed from having the narrowing shape in a case where the sliding body 210 is at the fully closed position, a case where the sliding body 210 is at the fully open position, and a case where the sliding body 210 is moving.

A position of the rib 52, the number of ribs 52, and arrangement of the rib 52 are not limited to the position, the number, and the arrangement illustrated in FIG. 3. For example, the rib 52 may be arranged at an end portion of the biasing member 50 in the width direction H. The biasing member 50 may include a plurality of ribs 52. The rib 52 may be arranged on a main surface of the main body 51 on a side opposite to the main surface 51a. The rib 52 may be provided on each of two main surfaces.

FIG. 6 illustrates another suppressing portion 2 according to the embodiment. The suppressing portion 2 in FIG. 6 is a tape member 3 wound around the biasing member 50. The tape member 3 increases rigidity of a portion of the biasing member 50 around which the tape member 3 is wound. For example, the tape member 3 is arranged at a position where the curved portions 33 and 34 of the biasing member 50 are formed. FIG. 6 illustrates the tape member 3 arranged at a portion forming the curved portion 33. In the following description, the portion forming the curved portion 33 in the biasing member 50 is referred to as a first portion 53.

In the curved portion 33 formed when the sliding body 210 is at the fully closed position, the first portion 53 has a tip portion 53a and two terminal end portions 53b. The tip portion 53a is a central portion of the first portion 53 and has a convex shape in the vehicle front-rear direction X. The terminal end portion 53b is an end portion of the first portion 53 in the vehicle up-down direction Y, and is a portion connected to linear portions 55 and 56. The linear portion 55 is a portion extending linearly along the rail 220. The linear portion 56 is a portion extending linearly along the sliding body 210.

The tape member 3 is wound around a range including the tip portion 53a of the first portion 53. A range in which the tape member 3 is provided on the biasing member 50 includes a predetermined range from the tip portion 53a toward the linear portion 55 and a predetermined range from the tip portion 53a toward the linear portion 56. A winding range of the tape member 3 may be a symmetrical range with respect to the tip portion 53a. The tape member 3 may be spirally wound around the biasing member 50. End portions connected to the linear portions 55 and 56 at the terminal end portions 53b are exposed from the illustrated tape member 3.

An angle α of the winding range of the tape member 3 with respect to the first portion 53 is, for example, an angle larger than 90°. The angle α may be 120°, 150°, or any other angle.

The tape member 3 is deformable according to deformation of the biasing member 50. The tape member 3 is configured to be stretchable, for example. The tape member 3 increases rigidity of a portion of the biasing member 50 around which the tape member 3 is wound.

The tape member 3 can increase rigidity of the first portion 53 of the biasing member 50 and suppress the first portion 53 from having the narrowing shape. The tape member 3 may be arranged at the portion forming the curved portion 34 in the biasing member 50. The portion forming the curved portion 34 has a tip portion and terminal end portions similar to the tip portion 53a and the terminal end portions 53b of the first portion 53. The tape member 3 is wound in a range including the tip portion of the portion forming the curved portion 34. The tape member 3 provided at the portion forming the curved portion 34 can suppress the biasing member 50 from having the narrowing shape at the curved portion 34.

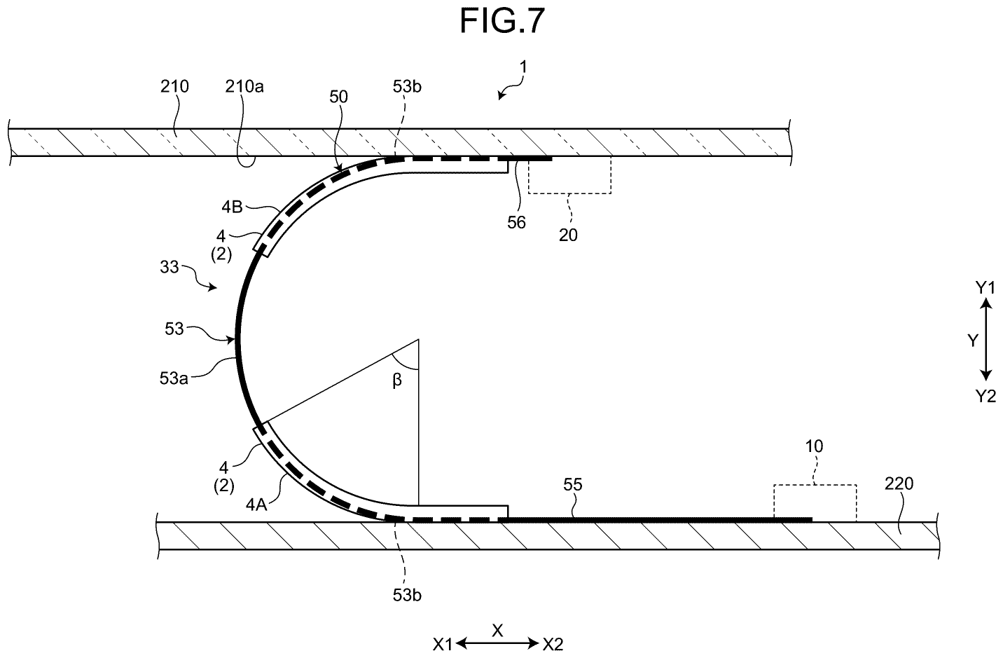

FIG. 7 illustrates another suppressing portion 2 according to the embodiment. The suppressing portion 2 in FIG. 7 is a tape member 4 wound around a portion forming the curved portion of the biasing member 50 at each of two positions. The tape member 4 is arranged on the first portion 53 in the biasing member 50, for example.

The tape member 4 is wound around a range including the terminal end portion 53b of the biasing member 50. The tape member 4 is, for example, spirally wound around the biasing member 50. Two tape members 4 include a first tape member 4A and a second tape member 4B. The first tape member 4A is wound around the terminal end portion 53b connected to the linear portion 55. A part of the first tape member 4A may be wound around the linear portion 55. An angle β of a winding range of the first tape member 4A with respect to the terminal end portion 53b may be 30°, 45°, 60°, or any other angle.

The second tape member 4B is wound around the terminal end portion 53b connected to the linear portion 56. A part of the second tape member 4B may be wound around the linear portion 56. An angle of a winding range of the second tape member 4B with respect to the terminal end portion 53b is, for example, the same as the angle β of the winding range of the first tape member 4A. As described above, a range in which the two tape members 4 are arranged is a range excluding the tip portion 53a which is the central portion of the first portion 53 and including the two terminal end portions 53b of the first portion 53.

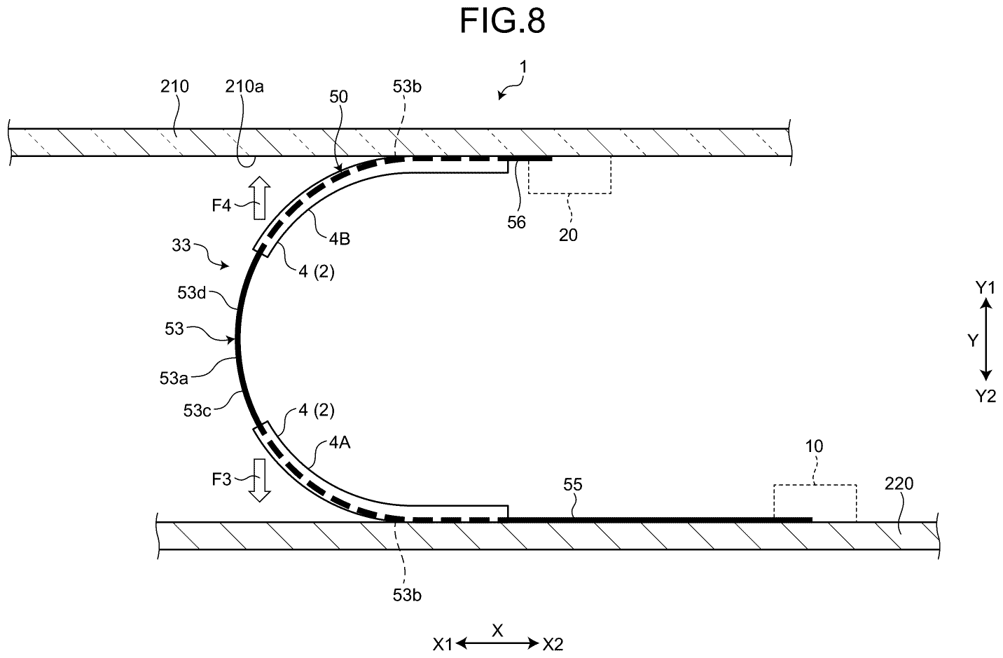

As illustrated in FIG. 8, when the biasing member 50 forms the curved portion 33, the first tape member 4A generates a reaction force F3. The reaction force F3 is a force having a component in the vehicle up-down direction Y. The reaction force F3 pulls one end portion 53c of the tip portion 53a toward the rail 220. When the biasing member 50 forms the curved portion 33, the second tape member 4B generates a reaction force F4. The reaction force F4 is a force having a component in the vehicle up-down direction Y, and pulls the other end portion 53d of the tip portion 53a toward the sliding body 210. That is, the reaction forces F3 and F4 are forces that pull the tip portion 53a in the vehicle up-down direction Y, and are forces that increase the bending radius of the tip portion 53a.

Therefore, the two tape members 4 can suppress the biasing member 50 from having the narrowing shape at the curved portion 33. The two tape members 4 are wound around the biasing member 50 so as to expose the tip portion 53a. That is, in the biasing member 50, the rigidity of the tip portion 53a is lower than rigidity of a portion around which the tape member 4 is wound. Therefore, it is possible to effectively suppress the biasing member 50 from having the narrowing shape at the curved portion 33 by the reaction forces F3 and F4.

The tape member 4 may be arranged at a position where the curved portion 34 is formed in the biasing member 50. The portion forming the curved portion 34 has the tip portion and the terminal end portions similar to the tip portion 53a and the terminal end portions 53b. The two tape members 4 are wound around the terminal end portions of the portion forming the curved portion 34. The two tape members 4 are arranged so as to expose the tip portion of the portion forming the curved portion 34.

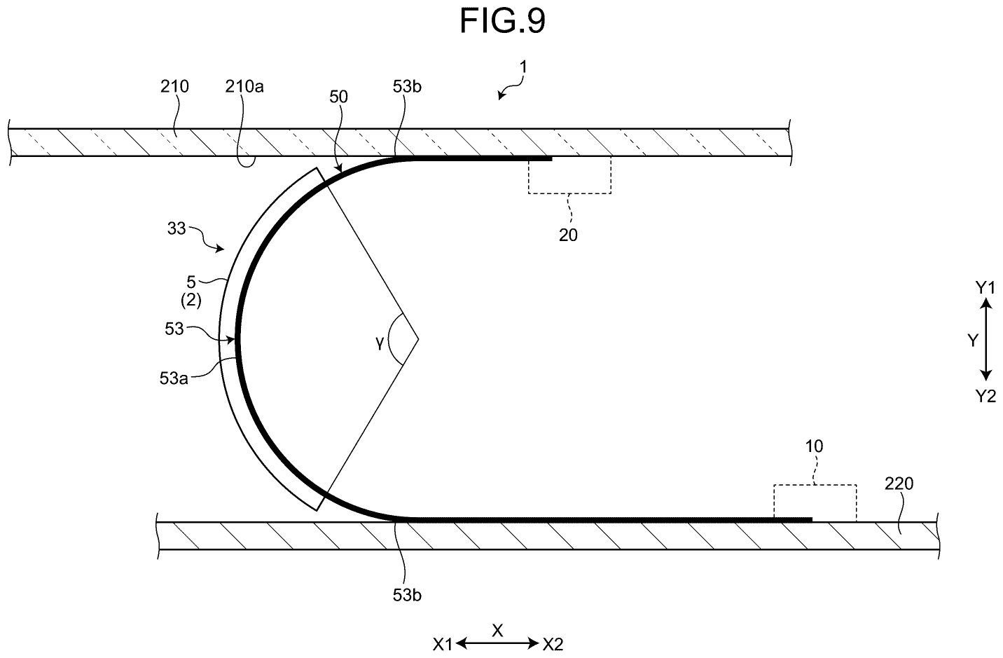

FIG. 9 illustrates another suppressing portion 2 according to the embodiment. The suppressing portion 2 in FIG. 9 is a coating layer 5 formed on the biasing member 50. The coating layer 5 is formed by, for example, resin coating. The coating layer 5 is deformable according to deformation of the biasing member 50. The coating layer 5 is, for example, an elastically deformable resin layer.

The coating layer 5 increases rigidity of a portion of the biasing member 50 where the coating layer 5 is provided. The coating layer 5 is provided, for example, at the first portion 53 forming the curved portion 33 in the biasing member 50. More specifically, the coating layer 5 is coated in a range including the tip portion 53a in the first portion 53. A range in which the coating layer 5 is provided on the biasing member 50 includes a predetermined range from the tip portion 53a toward the linear portion 55 and a predetermined range from the tip portion 53a toward the linear portion 56. A coating range may be a symmetrical range with respect to the tip portion 53a. The end portions connected to the linear portions 55 and 56 at the terminal end portions 53b are exposed from the illustrated coating layer 5.

The coating layer 5 is formed, for example, on an outward surface of the first portion 53 in the radial direction. An angle γ of the formation range of the coating layer 5 with respect to the first portion 53 is, for example, an angle larger than 90°. The angle γ may be 120°, 150°, or any other angle.

The coating layer 5 can increase rigidity of the portion forming the curved portion 33 in the biasing member 50 and suppress the biasing member 50 from having the narrowing shape at the curved portion 33. The coating layer 5 may be arranged at the portion forming the curved portion 34 in the biasing member 50. The portion forming the curved portion 34 has the tip portion and the terminal end portions similar to the tip portion 53a and the terminal end portions 53b. The coating layer 5 is formed in a range including the tip portion of the portion forming the curved portion 34. The coating layer 5 provided at the portion forming the curved portion 34 can suppress the biasing member 50 from having the narrowing shape at the curved portion 34.

The coating layer 5 may be formed on an inner surface of the portion forming the curved portion 33 or 34 in the radial direction, or may be formed on both the outer surface and the inner surface of the portion forming the curved portion 33 or 34 in the radial direction. The coating layer 5 may be formed in a tubular shape so as to surround the portion forming the curved portion 33 or 34.

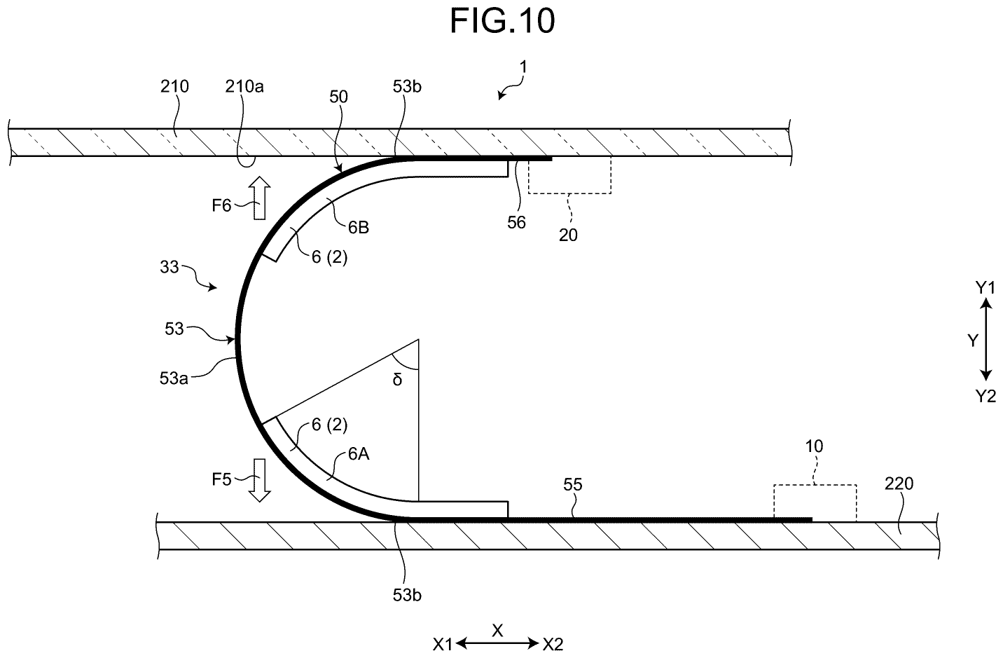

FIG. 10 illustrates another suppressing portion 2 according to the embodiment. The suppressing portion 2 in FIG. 10 is a coating layer 6 formed on a portion forming the curved portion of the biasing member 50 at each of two positions. The coating layer 6 is arranged, for example, at a position where the curved portion 33 is formed in the biasing member 50.

The coating layer 6 is formed on a range including the terminal end portion 53b of the biasing member 50. Two coating layers 6 include a first coating layer 6A and a second coating layer 6B. The first coating layer 6A is formed at the terminal end portion 53b connected to the linear portion 55. A part of the first coating layer 6A may be formed on the linear portion 55. An angle δ of a formation range of the first coating layer 6A with respect to the terminal end portion 53b may be 30°, 45°, 60°, or any other angle.

The second coating layer 6B is formed at the terminal end portion 53b connected to the linear portion 56. A part of the second coating layer 6B may be formed on the linear portion 56. An angle of a formation range of the second coating layer 6B with respect to the terminal end portion 53b is, for example, the same as the angle δ of the formation range of the first coating layer 6A.

A range in which the two coating layers 6 are arranged is a range excluding the tip portion 53a which is the central portion of the first portion 53 and including the two terminal end portions 53b of the first portion 53. When the biasing member 50 forms the curved portion 33, the first coating layer 6A generates a reaction force F5. The reaction force F5 is a force having a component in the vehicle up-down direction Y. The reaction force F5 pulls one end portion 53c of the tip portion 53a toward the rail 220.

When the biasing member 50 forms the curved portion 33, the second coating layer 6B generates a reaction force F6. The reaction force F6 is a force having a component in the vehicle up-down direction Y, and pulls the other end portion 53d of the tip portion 53a toward the sliding body 210. That is, the reaction forces F5 and F6 are forces that pull the tip portion 53a in the vehicle up-down direction Y, and are forces that increase the bending radius of the tip portion 53a.

Therefore, the two coating layers 6 can suppress the biasing member 50 from having the narrowing shape at the curved portion 33. The two coating layers 6 are wound around the biasing member 50 so as to expose the tip portion 53a. That is, in the biasing member 50, the rigidity of the tip portion 53a is lower than rigidity of a portion where the coating layer 6 is formed. Therefore, it is possible to effectively suppress the biasing member 50 from having the narrowing shape at the curved portion 33 by the reaction forces F5 and F6.

As described above, the routing structure 1 of the present embodiment includes the first fixed portion 10, the second fixed portion 20, the exterior member 30, the electric wire W, the plate-shaped biasing member 50, and the suppressing portion 2. The first fixed portion 10 is fixed to the vehicle body 110 of the vehicle 100. The second fixed portion 20 is fixed to the sliding body 210 that slides in the vehicle front-rear direction X with respect to the opening 120a provided in the roof 120 of the vehicle body 110. The exterior member 30 has the first end portion 30a held by the first fixed portion 10 and the second end portion 30b held by the second fixed portion 20. The electric wire W and the biasing member 50 are inserted into the exterior member 30.

The biasing member 50 forms the curved portion curved in the vehicle front-rear direction X between the first end portion 30a and the second end portion 30b of the exterior member 30. The suppressing portion 2 is provided in the biasing member 50, increases the rigidity of the portion forming the curved portion, and suppresses the biasing member 50 from having the narrowing shape at the curved portion. In the routing structure 1 of the present embodiment, the suppressing portion 2 can suppress the biasing member 50 from having the narrowing shape at the curved portion.

The rib 52 provided in the biasing member 50 and extending in the axial direction of the biasing member 50 is an example of the suppressing portion 2. The rib 52 can achieve both reduction in thickness of the main body 51 of the biasing member 50 and improvement in rigidity of the biasing member 50.

The tape members 3 and 4 wound around the biasing member 50 are examples of the suppressing portion 2. The tape members 3 and 4 can increase the rigidity of the biasing member 50 at the portions where the tape members 3 and 4 are provided and suppress the biasing member 50 from having the narrowing shape.

The coating layers 5 and 6 formed on the biasing member 50 are examples of the suppressing portion 2. The coating layers 5 and 6 can increase the rigidity of the biasing member 50 at the portion where the coating layers 5 and 6 are provided and suppress the biasing member 50 from having the narrowing shape.

The sliding body 210 of the present embodiment moves between the fully closed position where the opening 120a is closed and the fully open position where the opening 120a is opened. In the biasing member 50, a position where the suppressing portion 2 is arranged is, for example, a position where the curved portion 33 is formed when the sliding body 210 is at the fully closed position, or a position where the curved portion 34 is formed when the sliding body 210 is at the fully open position. The suppressing portion 2 may be provided at any one of the position where the curved portion 33 is formed and the position where the curved portion 34 is formed, or may be provided at both positions.

In the curved portion, a range in which the suppressing portion 2 is arranged in the biasing member 50 is a range excluding the central portion of the portion forming the curved portion 33 or 34 and including two terminal end portions of the portion forming the curved portion 33 or 34. The suppressing portion 2 arranged at the terminal end portion can generate the reaction force F3, F4, F5, or F6 to suppress the biasing member 50 from having the narrowing shape.

The exterior member 30 is not limited to a so-called corrugated tube. The exterior member 30 may be a braided tube or a member used as another exterior member. The biasing member 50 may be arranged outside the electric wire W. That is, the biasing member 50 may be arranged on an outer side of the electric wire W in the radial direction at the curved portions 33 and 34.

The contents disclosed in the above embodiment can be appropriately combined and executed.

The routing structure according to the present embodiment includes the suppressing portion provided on the biasing member. The suppressing portion increases the rigidity of the portion forming the curved portion and suppresses the biasing member from having the narrowing shape at the curved portion. With the routing structure of the present invention, it is possible to suppress the biasing member from having the narrowing shape.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a first fixed portion that is fixed to a vehicle body of a vehicle;
a second fixed portion that is fixed to a sliding body that moves in a vehicle front-rear direction with respect to an opening provided in a roof of the vehicle body;
an exterior member that has a first end portion held by the first fixed portion, and a second end portion held by the second fixed portion;
an electric wire that is inserted into the exterior member;
a plate-shaped biasing member that is inserted into the exterior member, and forms a curved portion curved in the vehicle front-rear direction between the first end portion and the second end portion of the exterior member; and
a suppressing portion that is provided on the biasing member, and increases rigidity of a portion forming the curved portion to suppress the biasing member from having a narrowing shape at the curved portion.

2. The routing structure according to claim 1, wherein
the suppressing portion is a rib provided in the biasing member and extending in an axial direction of the biasing member.

3. The routing structure according to claim 1, wherein
the suppressing portion is a tape member wound around the biasing member.

4. The routing structure according to claim 1, wherein
the suppressing portion is a coating layer formed on the biasing member.

5. The routing structure according to claim 1, wherein
the sliding body moves between a fully closed position where the opening is closed and a fully open position where the opening is opened, and
in the biasing member, a position where the suppressing portion is arranged is a position where the curved portion is formed when the sliding body is at the fully closed position or a position where the curved portion is formed when the sliding body is at the fully open position.

6. The routing structure according to claim 5, wherein
in the curved portion, a range in which the suppressing portion is arranged in the biasing member is a range excluding a central portion of the portion forming the curved portion and including two terminal end portions of the portion forming the curved portion.
